(19) United States
(12) Patent Application Publication
(10) Pub. No.: US 2010/0263753 A1
(43) Pub. Date: Oct. 21, 2010

(54) FLUID SUPPLY SYSTEM

(75) Inventors: Trevor Honeyman, County Durham (GB); Kenneth Robinson, County Durham (GB)

Correspondence Address: MCKEE, VOORHEES & SEASE, P.L.C., 801 GRAND AVENUE, SUITE 3200, DES MOINES, IA, 50309-2721, US

(73) Assignee: HYDROGIENIC GLOBAL TECHNOLOGY LIMITED, County Durham (GB)

(21) Appl. No.: 12/741,057

(22) PCT Filed: Nov. 6, 2008
(86) PCT No.: PCT/GB08/03733

§ 371 Date: Jun. 22, 2010

(30) Foreign Application Priority Data
Nov. 6, 2007 (GB) 0721702.9

(51) Int. Cl. F16K 11/00; G06F 17/50

(52) U.S. Cl. 137/597; 703/1

(57) ABSTRACT

The invention relates to apparatus and a method for the provision of fluid to a number of users via the selective opening of one or more offtakes of the system. The apparatus includes supply manifolds formed of modular units and the connections between first and second manifolds to the offtakes are designed so as to provide the required fluid characteristics at each offtake. The system also ensures the consistent supply of fluid to the offtakes regardless of the number of other offtakes which are open at that time.

The invention to which this application relates is to a fluid supply system which allows fluid, and typically, although not necessarily exclusively, a liquid, to be supplied by and taken from the system by users in an efficient manner.

The provision of reliable liquid supplies, at a plurality of different offtakes, which may be at spaced locations, is a significant problem, especially in commercial premises such as laboratories, testing areas, or commercial manufacturing processes, such as, for example, brewing or distilling.

In addition to being able to provide the fluid to each of the required offtake locations so that the fluid is available when the offtake is opened, there is also a need to be able to ensure that the particular pressure and/or flow of the fluid through each offtake is within predetermined parameters for that offtake and can be provided in a predictable and repeatable manner. Maintaining minimum velocities of flow is significant and important if the fluid being distributed has a requirement to sustain good microbial quality. Such velocities (above the turbulent velocity) discourage settlement of organisms on internal surfaces, and thus reduce the risk of biofilm formation on these inner surfaces.

Furthermore, there is the need to provide a system which allows fluid to be obtained even when a plurality of the offtakes are opened at the same time.

The applicant, in their granted patent No. EP1430252 discloses a system which allows liquid to be provided via one or more of a number of offtakes which are provided at different locations but connected as part of the same system. Each offtake can be opened and, when opened, liquid is supplied through the offtake at a predictable flow rate. The flow rate remains substantially constant, regardless of the number of offtakes which are open at that time. This is achieved by providing, to each offtake, an inlet and an outlet flow connection, such that when the offtake is opened, fluid is provided to the offtake from both the inlet and outlet connections. However, when the offtake is shut, the fluid flows to the offtake along the inlet connection and from the offtake along the outlet connection to form a fluid loop.

The system in accordance with the applicant's patent, has attracted significant commercial interest and further development work which has subsequently been undertaken, has resulted in further improvements which are described herein.

The aim of the present invention is therefore to provide a system for the supply of fluid, such as liquid, via a plurality of offtakes which are provided as part of the system and to do so in an improved manner and/or to allow the apparatus for providing the system to be provided in an improved manner for installation and subsequent usage.

In a first aspect of the invention, there is provided a fluid supply apparatus, said supply apparatus including a fluid flow pipework system having a plurality of offtakes via which fluid can be selectively extracted from the apparatus, said offtakes selectively openable and provided with first and second supply connections, said connections connected to first and second manifolds respectively and wherein at least one of said manifolds is formed from a plurality of modular units connected together.

Typically, each modular unit has at least one outlet to receive connection means for a connection to at least one offtake.

Thus, in one embodiment, the number of modular units joined together to create the manifold, is equal to the number of offtakes provided in the system.

In an alternative embodiment each modular unit has two outlets to receive connection means for connections to two offtakes.

Typically, each manifold includes an inlet connection via which fluid from the system enters the manifold with the fluid leaving the system via the one or more outlets on each of the modular units.

Typically, each modular unit for a manifold, incorporates a channel along which fluid can flow, said channels of the modular units, when combined together, forming a fluid channel along the manifold to each of the outlets.

In one embodiment, the system incorporates two manifolds, a first manifold from which connections act as an inlet connection to the offtakes and a second manifold from which connections act as a return connection to the offtakes.

In one embodiment, the modular units of the manifold which are connected to offtakes which have higher fluid flow or are used more frequently, are located towards the end of the manifold opposing that from which the fluid inlet is located. This ensures that the fluid at the remote end of the channel, experiences turbulence and is moved, so as to prevent or minimise the risk of contamination of the fluid.

In one embodiment, the manifolds are formed from the modular units and can be subsequently increased or decreased by attaching the appropriate number of modular units depending on the number of offtakes which are required to be supplied by the system at that time. Thus, the system in accordance with the invention is range taking and adaptable to allow the same to be expanded or reduced in size to reflect the particular usage requirements at any given time.

Typically, the modular units are connected together to form the manifold, via mechanical engagement means in conjunction with seals positioned therebetween.

In one embodiment, the manifolds are provided in conjunction with at least one fluid storage vessel, said fluid storage vessel connected to a first manifold via an outlet from the vessel, and to the second manifold via an inlet to the vessel.

In one embodiment, the fluid is a liquid, and said liquid flows from the storage vessel, to the first manifold, from the outlets of said manifold to respective offtakes, and if the offtakes are shut, via a valve and connector to the second manifold, through the same and back to the water storage vessel. If any of the offtakes are open at any given time, liquid is supplied to that offtake, from the first manifold and the second manifold as the flow of fluid between the offtake and the second manifold reverses when the offtake is opened. The flow of fluid to the other offtakes is unaffected and, furthermore, if any of the other offtakes are also opened, this will have no significant impact on the flow or pressure of supply of the liquid at any of the offtakes which are open at that time.

In one embodiment, the system includes heat exchangers and/or filters and/or fluid treatment devices such as for example ultraviolet lamps.

In one embodiment, the system incorporates a start-up mode in which the system may be validated, once installed, with said start-up mode including the connection of pipework between said first and second manifolds directly, without connection to each of the offtakes. Once the operation of the system has been validated, the said pipework can be disconnected or removed and full supply to the offtakes then commenced in normal operating mode.

In one embodiment, the validation mode is entered and completed, whenever a new offtake is added or an offtake is removed.

In one embodiment, the addition or removal of modular units from the manifolds, can be performed in a sealed manner inasmuch that the remainder of the system can remain operable during the addition or removal of the offtakes.

In one embodiment, each of the outlet connections on the manifold, if not at that time connected to an offtake connector, can be selected to be connected by the connection of a suitable pipe connector.

Preferably, each connector from the manifold to an offtake, is of a flexible hose material. Typically, each connector is manufactured to be as a single unit thereby avoiding the need for welding, the connection of sections of pipes and the like.

In a preferred embodiment, and in order to ensure that the fluid which is supplied from each offtake, is in the required form, the bore dimensions of each connector, are selected and controlled with respect to at least the distance of the offtake from the manifold which the connector is used to span and the user requirements for each particular offtake.

Typically the bore of the connectors is selected such that, when the system is closed, the velocity of the fluid flow is at a minimum turbulent velocity, typically of more than 6,000 Reynolds.

Typically the system which is formed by the apparatus is a closed system inasmuch that the fluid to be supplied is taken from the storage vessel.

In a further aspect of the invention there is provided a method of designing a system for the provision of a fluid to a plurality of offtakes, each of said offtakes selectively openable by the user to provide fluid at a required flow, said method comprising the steps of;

(a) determining the required fluid flow parameters for the system;
(b) determining the length of the connector required to span the distance between the location of an offtake and a first manifold of the system,
(c) repeating step (b) for a second connector and the distance between the said offtake and a second manifold;
(d) determining the operating conditions of the system when the offtake is shut,
(e) determining the operating conditions when the offtake is open; and wherein
the bore dimensions of the connectors to said offtake are selected so as to ensure that the fluid flow through the connectors is at or above turbulent velocity when the offtake is open and closed.

In one embodiment, the system incorporates a plurality of offtakes, and the method steps are repeated for each of the offtakes and for each of the connectors to each offtake.

In one embodiment, the method ensures that the fluid flow which is obtained from each offtake, is substantially as specified by the user and is substantially the same on repeated opening and closing of the offtakes and also regardless of the number of offtakes of the system which may be open at that time.

In one embodiment, the design of each of the connectors is undertaken with regard to the total number of offtake connectors which are provided and the specific user requirements. Thus, the system may be tailored for specific uses of the liquid which is being supplied.

Furthermore, the particular pressures of the liquid which is supplied at differing offtakes, can be selected. Thus, for example, an offtake of a system which is for use in sink taps, equipment preparation areas and the like, may have a relatively low pressure and other offtakes, connected to the same system, may have higher flow requirements or higher pressure requirements and therefore the liquid flow at these locations, can be provided accordingly.

Typically each of the modular units which, in conjunction, are used to form a manifold, are provided with a valve, for each of the outlets therefrom so as to allow independent control of the flow of fluid out of each outlet independently.

In a yet further aspect of the invention there is provided a method of providing a fluid from a supply to a plurality of offtakes, said offtakes selectively movable between open and closed positions, each of said offtakes having first and second connectors connecting the offtakes to first and second manifolds respectively, said fluid flowing, with respect to each offtake when closed, from the supply to a first manifold, to the offtake and from the offtake to the second manifold and to the supply, and wherein for an open offtake, the fluid flows from both the first and second manifolds to the open offtake.

Typically each of the manifolds is formed by connecting together a number of modular units, each of the units having a channel through which fluid flows between the respective units and at least one outlet/inlet which allows a connector to join the same to an offtake to allow fluid flow therealong.

In one embodiment the number of modular units used to form each manifold match the number of offtakes in the system.

Typically in whichever aspect or embodiment the fluid is a liquid and yet further can be a distilled or sterile or otherwise controlled or prepared water supply.

Specific embodiments of the invention will now be described with reference to the accompanying drawings, wherein:—

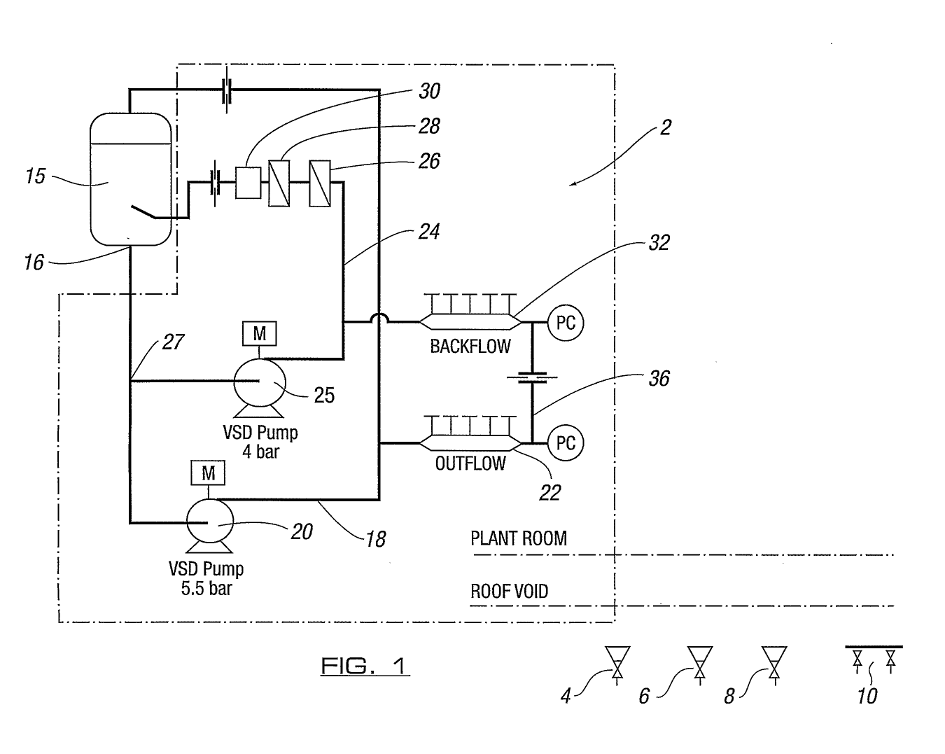

FIG. 1 illustrates a schematic diagram of a first embodiment of the invention, in a validation mode;

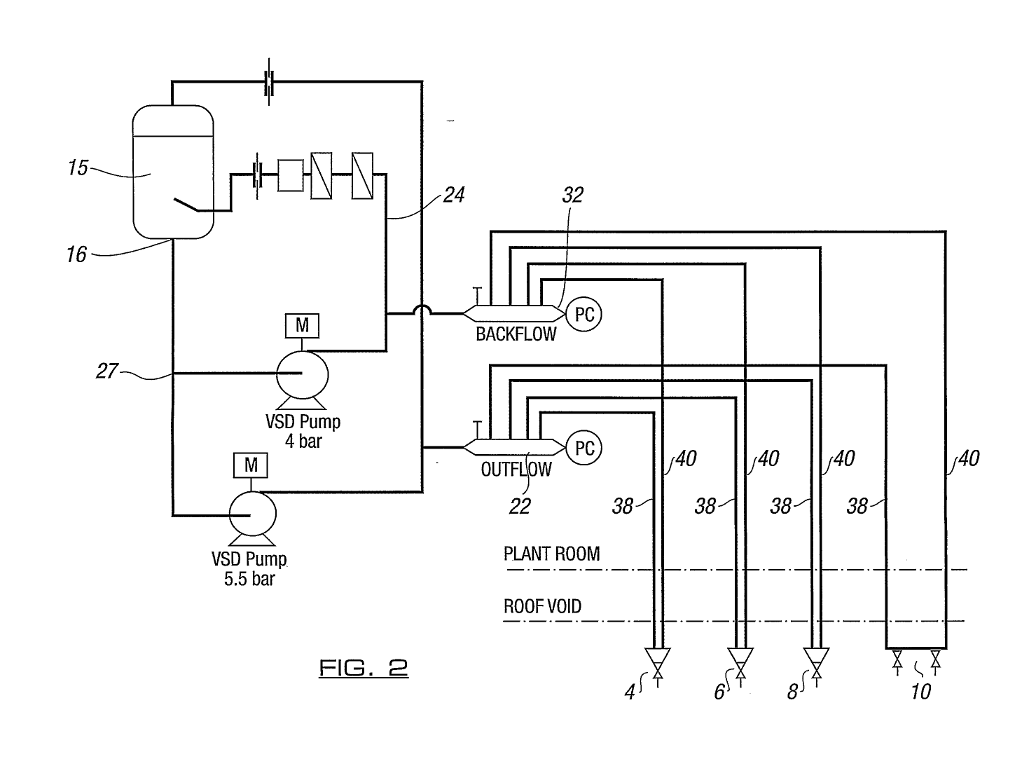

FIG. 2 illustrates the system of FIG. 1, in a normal operating mode; and

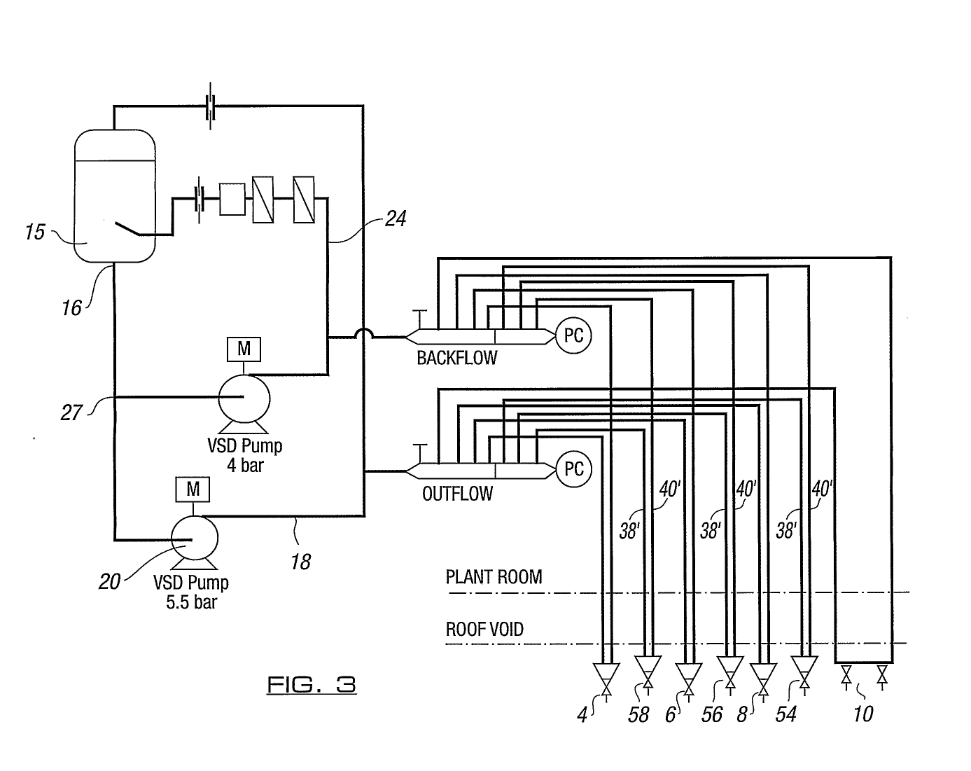

FIG. 3 illustrates the system of FIGS. 1 and 2, having been enlarged to incorporate further offtakes; and

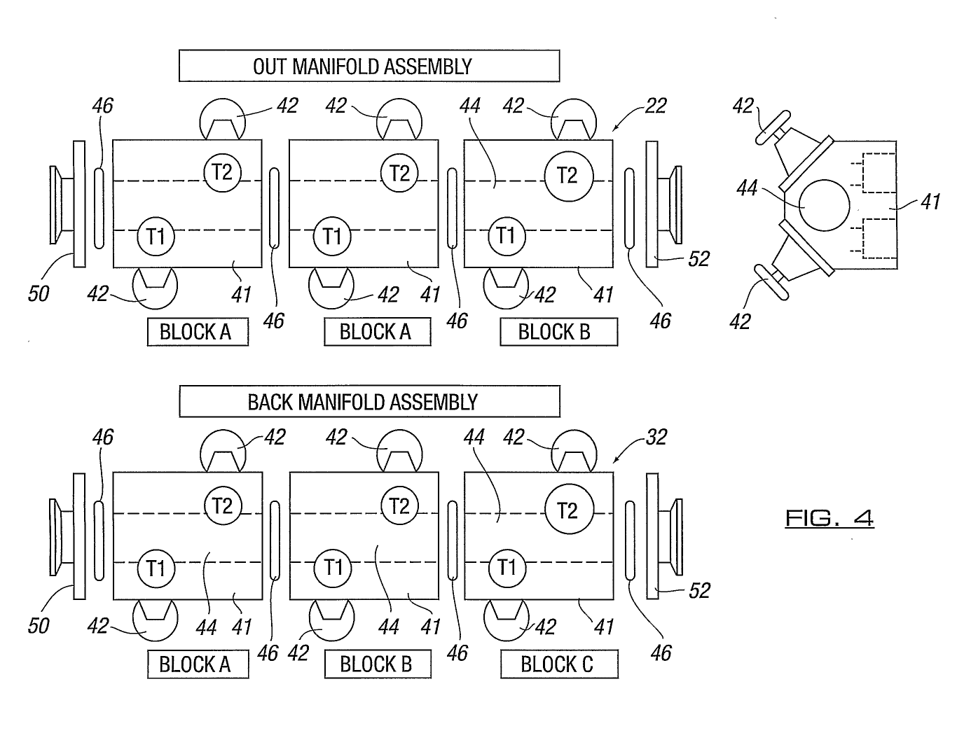

FIG. 4 illustrates one embodiment of the two manifold assemblies in accordance with the invention.

Referring firstly to FIG. 1, there is illustrated a system 2 in accordance with a first embodiment of the invention in which the apparatus is being validated prior to the normal mode of operation.

In this case, the system is provided to allow the supply of a fluid, such as water, to a number of offtakes 4, 6, 8, 10. Each of the offtakes, can be provided at a selected location within a premises such as, for example, different rooms or laboratories within a building. In the validation mode shown in FIG. 1 the outlet 16 from the storage vessel 15, is connected to a first loop 18 which has a pump 20 and which is connected to a first, outflow manifold 22. There is also provided a connection to a second loop 24 with a pump 25 and this second loop allows fluid to pass through heat and cool heat exchangers 26, 28 and UV lamp 30 to treat the fluid. This second loop is connected to a second, backflow manifold 32. The particular makeup of the outflow and backflow manifolds, are shown in more detail subsequently. The second fluid flow loop 24 is connected to the first loop at a location 27 between the storage vessel and the first manifold.

In the validation mode, the manifolds 22,32 are not connected to the offtakes, but rather a temporary connection 36 is provided which connects the outflow manifold 22 to the input of the backflow manifold 32. In this configuration, the system can be tested by passing liquid round the system via the connection 36.

Once the system has been found to meet the required operating conditions, the pipework connection 36 between the manifolds, is removed or at least closed off and connectors between the manifolds 22, 32 and each of the offtakes are put into place as shown in FIG. 2. Each offtake, 4, 6, 8, 10 has a pipe inlet connector 38 from the outflow manifold 22 and a pipe outlet connector 40 to the backflow manifold 32, as shown. The particular bore dimension such as the inner diameter of each of the connectors, is selected with regard to the required fluid flow at the particular offtake to which the connector is to be connected, the distance from the respective manifold to the offtake for each connector, and the required pressure of the fluid to be supplied at the offtake.

It should be appreciated that it is preferred that each connector will be a single, unitary hose connector which therefore means that no connections are required to be made along the length of the connector and furthermore the flexibility of the hose allows the same to be more adaptable when routing the same to the offtake. For example, the pipework may typically be located in the void spaces of a premises until reaching the location of the offtake, at which point the connection to the offtake is made, with the offtake being positioned as required within an area of the premises.

In normal operating conditions, if the offtake is closed, the water will flow along a connector 38 from the outflow manifold 22 to the offtake, and then from the offtake to the backflow manifold 32 via the connector 40 and then back into the system to re-circulate. If an offtake is opened this causes the water will flow from the outflow manifold 22 to the offtake via the connector 38 and from the backflow manifold 32 to the offtake via respective connector 40 so that the fluid can be supplied to the user via the open offtake at the required flow and velocity.

The manifolds 22,32 are each constructed from a plurality of modular units 41, as shown in FIG. 4 wherein there is shown the outflow manifold assembly 22 and the backflow manifold assembly 32. Each of the modular units 41 has, in this embodiment, first and second apertures T1, T2. Each of these apertures is provided with a valve arrangement 42 which is selectively openable and closable by the user and/or operator of the system. Each of the apertures is connectable to one end of the connector 38, 40 to an offtake, typically by a plug-in form of connection. Each of the apertures T1, T2 is in fluid connection with a channel 44 which passes along the length of the interior of the manifold.

Thus, in accordance with the outflow manifold 22, liquid enters the same at one end and leaves the same via each of the apertures T1 and T2 of each unit 40. With regard to the backflow manifold 32, liquid enters the manifold via each of the apertures T1, T2 and leaves the manifold at one end of the channel 44. The units 40 are connected end to end, in parallel, with seals 46 being located between each modular unit 40 as shown. The modular units are then typically clamped in position by end clamps 50, 52 so as to ensure that a fluid-tight seal is created between the respective modular units.

The ability to provide modular units in a parallel arrangement, has several advantages. Firstly, any given outlet or inlet T1, T2 can be closed off, without affecting the operation and fluid flow through the other outlets.

Secondly, if required, additional modular units can be added or removed from the manifold and FIG. 3 illustrates one such arrangement where additional modular units have been added to each of the manifolds 22, 32, to allow three new offtakes 54, 56, 58 to be added to the system with new connectors 38′, 40′ provided from the manifolds 22,32 to each. The addition of these offtakes can be achieved, without shutting down the operation of the system. In addition, modular units may be used to increase the number of offtakes overall, or, may be used to replace previous offtakes such that, for example, the new offtakes 54, 56, 58 are added to the system, are made operational, and then the old offtakes 4, 6, 8, 10 and connections 38, 40 therefor and modular units 41, can be shut down and, if required, removed from the manifolds without any failure in supply to the user.

The design of the specific dimensions of the bore of the connectors between the manifolds and offtakes ensures that the particular required supply parameters at each offtake can be achieved. Furthermore, the design of the overall system to achieve a fluid flow with a minimum turbulent velocity of greater than 6,000 Reynolds ensures that the fluid is supplied in the required condition for use in controlled environment and purposes when the offtake is opened and at a constant flow, regardless of the other offtakes open at that time.

The present invention therefore provides an adaptable and efficient fluid supply system which allows fluids to be supplied at offtakes connected to the system, efficiently and at repeated levels of pressure.

1. Fluid supply apparatus, said supply apparatus including a fluid flow pipework system having a plurality of offtakes via which fluid can be selectively extracted from the apparatus, said offtakes selectively openable and provided with first and second supply connections, said connections connected to first and second manifolds respectively and wherein at least one of said manifolds is formed from a plurality of modular units connected together.

2. Apparatus according to claim 1 wherein each modular unit has at least one outlet to receive connection means for a connection to at least one offtake.

3. Apparatus according to claim 2 wherein the number of modular units joined together to create each manifold, is equal to the number of offtakes provided in the system.

4. Apparatus according to claim 1 wherein each modular unit has two outlets to receive connection means for connections to two offtakes.

5. Apparatus according to claim 1 wherein each manifold includes an inlet connection via which fluid enters the manifold with the fluid leaving the system via the one or more outlets on the modular units.

6. Apparatus according to claim 1 wherein each modular unit incorporates a channel along which fluid can flow, said channels of the modular units, when combined together, forming a fluid channel along the manifold to the outlets.

7. Apparatus according to claim 1 wherein the system incorporates two manifolds, a first manifold from which connections act as an inlet connection to the offtakes and a second manifold from which connections act as a return connection to the offtakes.

8. Apparatus according to claim 1 wherein the modular units of the manifold which are connected to offtakes which have a relatively higher fluid flow, or are used more frequently, are located towards the end of the manifold opposing that from which the fluid inlet is located.

9. Apparatus according to claim 1 wherein the manifolds can be increased or decreased in size by attaching the appropriate number of modular units depending on the number of offtakes which are required to be supplied with fluid by the apparatus.

10. Apparatus according to claim 1 wherein the modular units are connected together to form the manifold via mechanical engagement means in conjunction with seals positioned therebetween.

11. Apparatus according to claim 1 wherein the manifolds are provided in conjunction with at least one fluid storage vessel, said fluid storage vessel connected to a first manifold via an outlet from the vessel and an inlet to the manifold, and to a second manifold via an outlet from the manifold and an inlet to the vessel.

12. Apparatus according to claim 11 wherein the fluid flows from the storage vessel to the first manifold, from the outlets of said manifold to the respective offtakes, and if the offtakes are shut, via a valve and connector to the second manifold, through the same and back to the storage vessel.

13. Apparatus according to claim 12 wherein the fluid flows from the storage vessel to the first manifold via a first connecting fluid flow loop and from the second manifold to the storage vessel via a second fluid flow loop.

14. Apparatus according to claim 13 wherein the second fluid flow loop is connected to the first loop at a location between the storage vessel and the first manifold.

15. Apparatus according to claim 12 wherein any of the offtakes that are open at any given time are supplied with the fluid from the first manifold and the second manifold as the flow of fluid between the open offtakes and the second manifold reverses when the offtake is opened.

16. Apparatus according to claim 15 wherein the flow of fluid to and from the other offtakes is unaffected.

17. Apparatus according to claim 15 wherein the flow and/or pressure of the flow of fluid to an open offtake is not significantly impacted by the particular number of other offtakes which are open at that time.

18. Apparatus according to claim 1 wherein the apparatus includes any or any combination of heat exchangers and/or filters and/or fluid treatment devices to act on the fluid within the apparatus.

19. Apparatus according to claim 1 wherein the apparatus can be operated in a start up or validation mode in which the apparatus includes the provision of connectors between said first and second manifolds directly, without connection to each of the offtakes.

20. Apparatus according to claim 19 wherein, after start up and/or validation of the apparatus, the said connectors are disconnected and removed and connectors installed between the manifolds and offtakes to allow the selective supply of fluid to the offtakes in a normal operating mode.

21. Apparatus according to claim 19 wherein the validation mode is entered and completed whenever a new offtake is added or an offtake is removed.

22. Apparatus according to claim 21 wherein the addition or removal of modular units from the manifolds is performed in a sealed manner inasmuch that the remainder of the system can remain operable during the addition or removal of the offtakes.

23. Apparatus according to claim 1 wherein each of the outlet connections on the manifold, if not at that time connected to an offtake connector is sealed and can be selected to be connected to an offtake via a suitable connector.

24. Apparatus according to claim 1 wherein the connector from the manifold to an offtake, is of a flexible hose material.

25. Apparatus according to claim 24 wherein the connector is manufactured as a single unit.

26. Apparatus according to claim 1 wherein the bore dimensions of respective connectors between the manifolds and offtakes are selected with respect to the particular offtake to which it is to be connected.

27. Apparatus according to claim 26 wherein the bore dimensions may be different from connector to connector.

28. Apparatus according to claim 26 wherein the bore dimensions of each connector from a manifold to an offtake are selected and controlled with respect to at least the distance of the offtake from the manifold and/or the user requirements for fluid supply from the particular offtake.

29. Apparatus according to claim 1 wherein the bore dimensions of the connector are selected such that, when no offtakes are open the fluid flow through the apparatus is at a minimum turbulent velocity of greater than 6,000 Reynolds.

30. Apparatus according to claim 1 wherein each of the modular units which, in conjunction, are used to form a manifold, are provided with a valve for each of the outlets therefrom so as to allow independent control of the flow of fluid out of each outlet.

31. Apparatus according to any of the preceding claims wherein the apparatus forms a closed fluid supply system.

32. A method of designing a system for the provision of a fluid to a plurality of offtakes, each of said offtakes selectively openable by the user to provide fluid at a required flow, said method comprising the steps of;
(a) determining the required fluid flow parameters for the system;
(b) determining the length of the connector required to span the distance between the location of an offtake and a first manifold of the system,
(c) repeating step (b) for a second connector and the distance between the said offtake and a second manifold;
(d) determining the operating conditions of the system when the offtake is shut,
(e) determining the operating conditions when the offtake is open; and wherein
the bore dimensions of the connectors to said offtake are selected so as to ensure that the fluid flow through the connectors is at or above turbulent velocity when the offtake is open and closed.

33. A method according to claim 32 wherein the system incorporates a plurality of offtakes, and the method steps are repeated for each of the offtakes.

34. A method according to claim 32 wherein the fluid flow which is obtained from each offtake, is substantially the same on repeated opening and closing of the offtakes and regardless of the number of offtakes of the system which may be open at that time.

35. A method according to claim 32 wherein the design of each of the connectors is undertaken with regard to the total number of offtake connectors which are provided in the system and the specific user requirements at each of the offtakes.

36. A method according to claim 32 wherein the system is designed with respect to the specific use of the fluid which is being supplied.

37. A method according to claim 32 wherein the pressure of the fluid which is supplied at differing offtakes, can be selected to vary.

38. A method of providing a fluid from a supply to a plurality of offtakes, said offtakes selectively movable between open and closed positions, each of said offtakes having first and second connectors connecting the offtakes to first and second manifolds respectively, said fluid flowing, with respect to each offtake when closed, from the supply to a first manifold, to the offtake and from the offtake to the second manifold and to the supply, and wherein for an open offtake, the fluid flows from both the first and second manifolds to the open offtake.

39. A method according to claim 38 wherein each of the manifolds is formed by connecting together a number of modular units, each of the units having a channel through which fluid flows between the respective units and at least one outlet/inlet which allows a connector to join the same to an offtake to allow fluid flow therealong.

40. A method according to claim 38 wherein the number of modular units used to form each manifold match the number of offtakes in the system.

41. A method according to any of the preceding claims wherein the fluid is a liquid.

42. A method according to claim 41 wherein the liquid is water.
